(19) United States
(12) Patent Application Publication
(10) Pub. No.: US 2003/0061126 A1
(43) Pub. Date: Mar. 27, 2003

(54) Method of determining inventory levels

(75) Inventors: Yesim Erke, Allentown, PA (US); Yi-Hui Christina Ma, Mechanicsburg, PA (US); Mark C. Booth, Shippensburg, PA (US)

Correspondence Address: John R. Pivnichny, IBM Corporation, N50/040-4, 1701 North Street, Endicott, NY, 13760, US

(73) Assignee: International Business Machines Corporation, Armonk, NY

(21) Appl. No.: 09/879,677

(22) Filed: Jun. 12, 2001

(51) Int. Cl. G06F 17/60

(52) U.S. Cl. 705/28

(57) ABSTRACT

Optimum inventory levels are determined for parts in a network of neighboring part facilities serving a plurality of customers. A part procurement time performance measure is met or exceeded while minimizing overall inventory cost including holding, handling, and transportation costs. Alternatively an upper bound on inventory cost is met while maximizing a part procurement time measure.

### TECHNICAL FIELD

This invention relates generally to a method for determining inventory levels of replacement parts in a network of neighboring part facilities. More particularly the invention relates to a method of optimizing a customer oriented performance criteria while minimizing overall costs among the facilities.

### BACKGROUND OF THE INVENTION

Many manufacturing, retail, and other businesses use an associated after-market service business to supply replacement parts to their customers. Where there is sufficient demand for replacement parts, the parts business may set up facilities each having parts inventories at locations near to where the demand is greatest. For example, a company may have several parts facilities located within a short distance of a large metropolitan area e.g. Boston, Mass. if there is a sufficient number of customers scattered about the area.

Several smaller facilities may be set up rather than one larger facility depending on the relative location and parts used by the customers in order to better service the various customers' needs. Factors such as distance to the customers, transportation costs, holding or storage costs, criticality of the customer's needs and others may be taken into account when deciding where to locate such facilities. Hierarchical levels of facilities are typically established with the higher levels suppling parts to the smaller, more locally situated facilities.

In some applications, parts are grouped according to a subjective evaluation of their importance. Different part service level objectives are then specified for each of the groups with the most important group having the highest expected part service level.

Naturally the service business will also want to minimize the various costs associated with keeping parts in inventory at these facilities while at the same time providing excellent response to their customer's needs. Various methods have therefore been developed to address this tradeoff between high cost and good customer service in this and similar part inventory situations.

Caveney et al. in U.S. Pat. No. 5,608,621 describe a system and method for controlling the number of parts in an inventory. For each part in an inventory, a service level is defined as the fraction of total orders (for that part) which are filled from stock. The term “fill rate” is also used in the art for this definition. A minimum unit replenishment quantity (MURQ) and a safety unit quantity (SUQ) are defined for each part. Caveney further defines a part data table for each part. In the table are the number of units of the part in inventory, the forecast unit demand for the part, cost of the part, historical data on the number of units per order and the number of parts needed in inventory for each of a plurality of service levels for the part.

The method of Caveney then allows for entry of an inventory investment constraint. A processer determines the expected number of fillable orders from stock and the slope for each part service level for each part. The processer may also determine the MURQ and SUQ for each part. An optimization routine therefore provides an optimum service level for a specified inventory investment constraint. Alternatively an optimized inventory investment level may be determined for a specified inventory service level constraint.

Sheldon et al. in U.S. Pat. No. 5,765,143 describe a method of estimating demand for a part at an auto parts store by using data from other parts stores at the same level of distribution. Inventory is set for a high fill rate based on this estimated demand.

Ettl et al. in U.S. Pat. No. 5,946,662 optimize total expected inventory capital throughout a supply chain network while satisfying customer service level e.g. fill rate requirements using gradient information.

Feigin et al. in U.S. Pat. No. 6,006,196 describe a method for estimating on hand inventory and replenish requirements for a distribution network using a modified distribution resource planning (DRP) logic. Inventory levels are controlled based on these estimates.

When a facility does not have a requested part in stock it will normally contact its supplying facility up one step in the distribution hierarchy. If that facility can not provide the part, a facility will sometimes contact other local facilities to find one which has the part in stock. If successful, an ad hoc transaction is conducted to purchase and ship the part. Peterson et al. in WIPO application WO99/14698 describe an information network to facilitate this searching and negotiation capability.

All of the aforementioned methods emphasize a service level based on whether or how often a facility has the requested parts in stock. Applicants have found that customers with highly critical parts needs are more interested in the time required to provide the part to the customer's place of business. For example if the customer needs the part to repair a piece of high volume production equipment, then lack of a part, even for an hour or two may mean huge production losses for the customer. An improved inventory optimization system and method which addresses these and other customer needs would therefore be a desirable objective.

### OBJECTS AND SUMMARY OF THE INVENTION

It is therefore a principal object of the present invention to enhance the parts inventory art by providing a method with enhanced customer service capabilities.

It is another object to provide a method for optimizing customer part procurement time.

It is further object to provide a system for implementing such improvements.

These and other objects are attained in accordance with one embodiment of the invention wherein there is provided a method of determining inventory levels of parts for a plurality of stocking locations, the method comprising the steps of, providing data for a plurality of customer locations, unit price of the parts, request rates for each of the parts for each of the customer locations, handling costs for each of the stocking locations, and travel time and transportation cost between the stocking locations, specifying a parts procurement time (PPT) performance measure, entering the data and the performance measure into an optimization computer program, computing the inventory levels of the parts for the plurality of stocking locations using the optimization computer program, and ordering sufficient numbers of the parts to maintain the inventory levels at the plurality of stocking locations.

In accordance with another embodiment of the invention there is provided a computer implemented method of specifying parts inventory levels for a network of stocking locations, the method comprising the steps of, providing data for a plurality of customer locations, unit price of the parts, request rates for each of the parts for each of the customer locations, handling costs for each of the stocking locations, and travel time and transportation cost between the stocking locations, specifying a parts procurement time performance measure, formulating a mixed integer optimization model of the network, and entering the model on a processor to solve the mixed integer model to obtain the inventory levels for each of the stocking locations in the network.

In accordance with yet another embodiment of the invention there is provided a computer system for controlling inventory levels of parts for a plurality of stocking locations, comprising, a processor, one or more files on the computer system containing data for a plurality of customer locations, unit price of the parts, request rates for each of the parts for each of the customer locations, handling costs for each of the stocking locations, and travel time and transportation cost between the stocking locations, means for computing on the processor a parts procurement time performance measure, an optimization computer program on the processor for calculating the inventory levels of parts for the plurality of stocking locations, and an ordering system on the computer system for maintaining the inventory levels at the plurality of stocking locations.

### BRIEF DESCRIPTION OF THE DRAWINGS

The foregoing and other objects, aspects, and advantages thereof will be better understood from the following detailed description of a preferred embodiment of the invention with reference to the drawings, in which:

FIGS. 1a, and 1b show a network of stocking locations in a neighborhood of a primary stocking location;

FIG. 2 shows a second network with some stocking locations outside a two hour neighborhood;

FIG. 3 is a flowchart of process steps in accordance with one embodiment of the invention;

FIG. 4 is a data flow diagram for several computational steps of the present invention; and

FIG. 5 is a graph of inventory cost vs service level.

### BEST MODE FOR CARRYING OUT THE INVENTION

For a better understanding of the present invention, together with other and further objects, advantages, and capabilities thereof; reference is made to the following disclosure and the appended claims in connection with the above-described drawings.

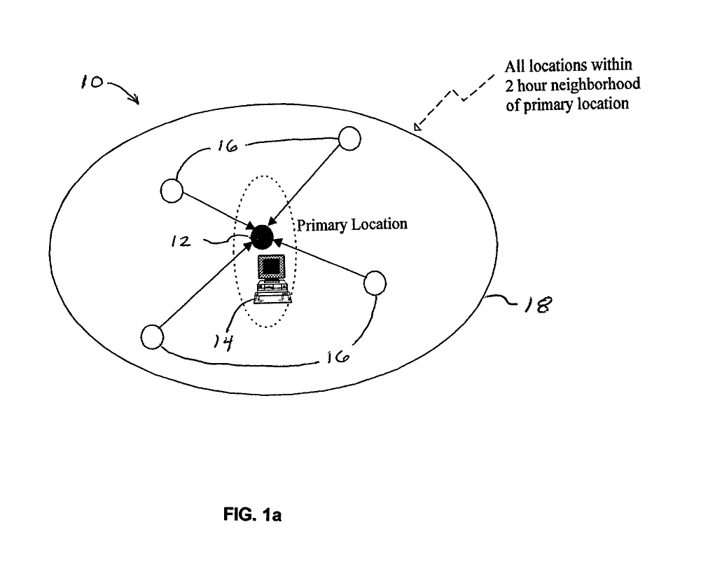

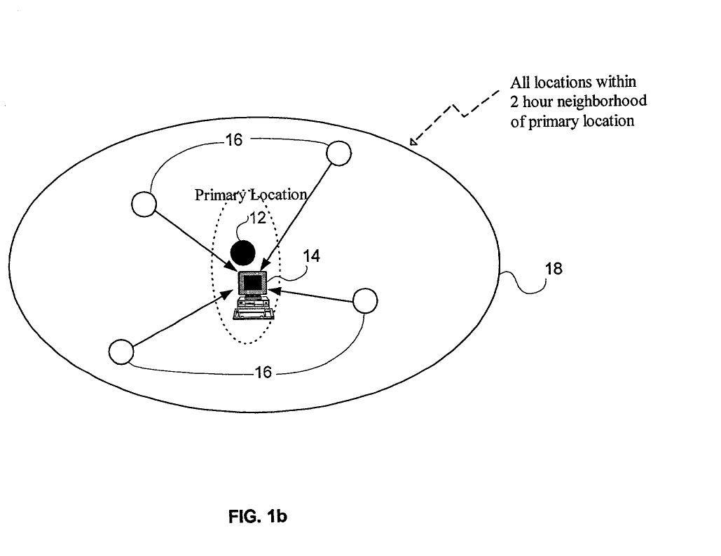

In FIGS. 1a and 1b there is shown a customer 14 having a demand for a part. The customer is depicted as a personal computer in FIGS. 1a and 1b but the customer's demand may arise for any reason. For example a repair part may be needed to replace a failed part in a piece of machinery or office equipment such as the personal computer of FIGS. 1a and 1b. A part may also be needed due to normal or abnormal wear-out mechanisms. A customer 14 may have one or many pieces of equipment installed or operating at his location. Parts to satisfy the demand of customer 14 are supplied by a nearly part facility 12. Facility 12 is designated as the primary location for customer 14. Other part facilities 16 may be located further away from customer 14, however as shown in FIGS. 1a and 1b, there are four other part facilities 16 located within a pre-specified, e.g. two hour travel time of primary location 12. Other part facilities 16 normally serve as a primary location for other customers (not shown). Boundary 18 defines the outer limit of all possible geographic locations within a pre-specified travel time of primary location 12. The region within boundary 18 is referred to herein as a neighborhood 10 of primary location 12. In FIG. 1a the neighborhood is a 2 hour neighborhood.

When a part demanded by customer 14 is not in stock at primary location 12, other 16 locations are queried to see whether any of these has the part and if so the part is shipped to primary location 12 as denoted by arrows from other location 16 to primary location 12. The part may also be shipped directly to customer 14 as shown in FIG. 1b.

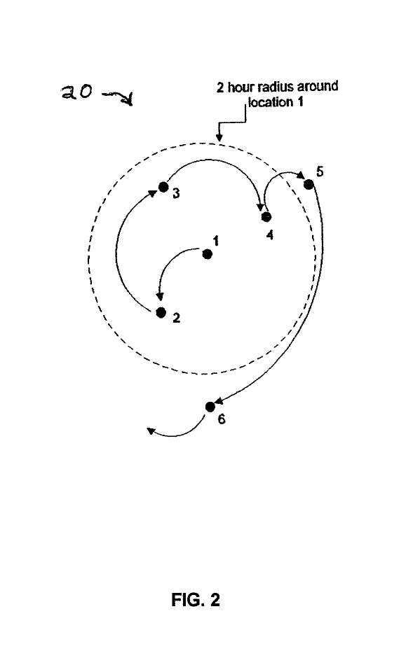

In FIG. 2 there is shown a network 20 of part facilities 1 through 6 with 1 being a primary location for a particular customer (not shown). Facilities 2-4 are shown as located within a two hour neighborhood of facility 1 and facilities 5-6 lie outside the two hour neighborhood. As noted above, primary location 1 will ad hoc contact other locations to determine whether these can provide a part from stock which is not in stock at primary location 1. Often this ad hoc procedure involves contacting other locations in sequence starting with the closest and proceeding outward as shown by the path of arrows in FIG. 2. Note that if locations 1-4 do not have a part in stock but 5 or 6 do, then the demand can not be satisfied within two hours.

For the network of FIG. 2, Table 1 below lists an example of that fill rates might be for a particular stocking level solution if a customer demand were to be filled by each of locations 1-6 alone. The third column of Table 1 lists the corresponding probabilities that the customer demand will not be filled by each location 1-6 when taken alone.

TABLE 1

| Location | Fill Rate | P (No Parts) |
|---|---|---|
| 1 | 0.90 | 0.10 |
| 2 | 0.92 | 0.08 |
| 3 | 0.91 | 0.09 |
| 4 | 0.89 | 0.11 |
| 5 | 0.90 | 0.10 |
| 6 | 0.90 | 0.10 |

Table 2 below lists for the given stocking levels of Table 1, the probability that a part is supplied by a particular location using the ad hoc neighborhood procedure, taking the supply locations in sequence as described above. There is a 0.9 probability that the part will be supplied by primary location 1. There is a 0.92 probability that the unsupplied 0.1 from location 1 will be supplied by location 2. Therefore the overall probability that a part is supplied by location 2 using the sequence procedure is 0.092×0.01=0.092. The probability that the part is supplied by location 1 or 2 is just the sum of the entries in Table 2 for locations 1 and 2 or 0.992. Continuing in this manner, there is a 0.91 probability that the remaining unfilled 0.008 will be supplied by location 3.

TABLE 2

| 1 | 2 | 3 | 4 | 5 | 6 |
|---|---|---|---|---|---|
| 0.9 | 0.092 | 0.0073 | 0.00064 | 0.00007 | 0.000007 |

P(part is acquired for location. . .)
P(part available in the neighborhood) = 0.99994

Obviously, a neighborhood fill procedure dramatically increases the probability that a part demand will be filled. In the example of Tables 1 and 2, as indicated, the probability that a part will be filled from the neighborhood is the sum of entries 1 to 4 of Table 2 (locations 5 and 6 are outside the neighborhood). Any ad hoc or neighborhood procedure when used in practice, but not planned for when determining stocking levels, as typically done in hierarchical networks, will provide overall fill rates which are higher than planned, as the example of Tables 1 and 2 illustrates.

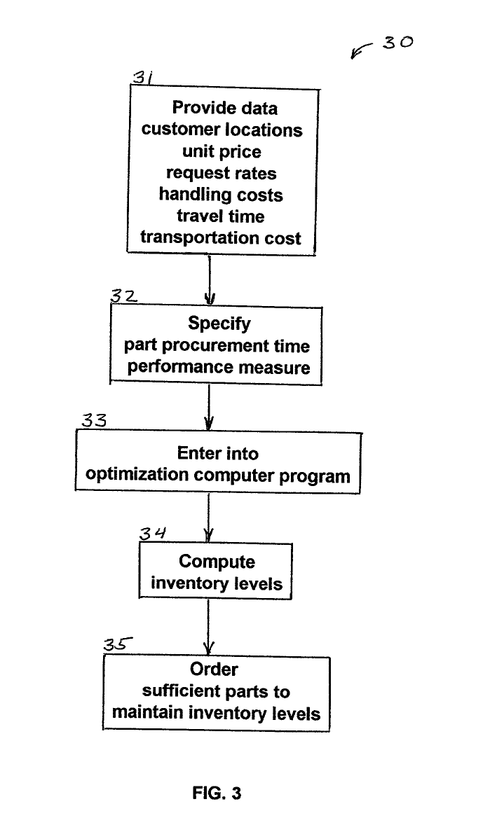

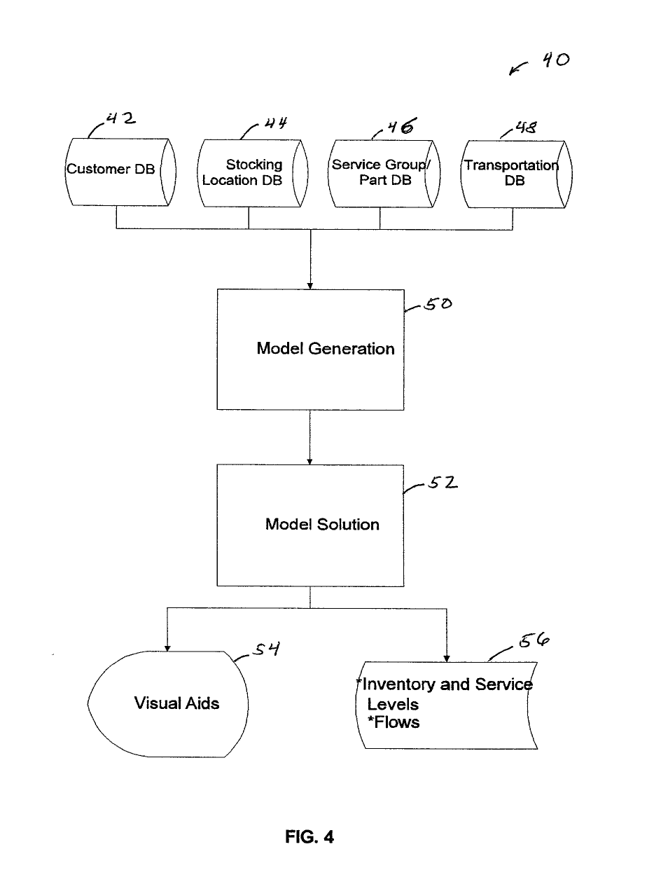

In FIG. 3 there is shown a process flowchart 30 for one embodiment of the present invention. In step 31 data is provided describing various aspects for a plurality of stocking locations. For example, data is provided for a plurality of customer locations including geographic location. The unit price of the parts needed by each customer is provided. Request rates for each of the parts for each customer is provided. Cost data for handling costs, transportation costs between stocking locations, and other costs associated with inventory are provided. Travel time between stocking locations is also provided. All of the data provided in step 31 may be provided in the form of databases such as the four databases 42, 44, 46, 48 of FIG. 4.

Customer database 42 may include for each customer listings of the products owned or used, service contract requirements, physical location of each product, as well as the primary stocking location assigned.

Stocking location database 44 has information about the stocking locations and corresponding handling costs.

Information regarding the failure or replacement rates for individual parts in the products that use those parts is included in the Service Group/Part Database 46. The importance or criticality of a part as well as the unit price of each part may be stored in this database.

Transportation database 48 includes all transportation contract information along with transportation cost and travel time between customer and stocking location pairs. It also includes transportation cost between each stocking location and any replenishment centers, such as the hierarchical supply centers mentioned above, that are used to replenish that stocking location.

For simplicity of analysis, it is usually assumed that the primary stocking location for each customer is the stocking location closest to the customer. Further the assumption may be made that other locations will ship parts to a primary location when requested as shown in FIG. 1a, and that the transportation cost and time to do so is essentially the same as if the part were shipped from the other location directly to the customer as in FIG. 1b. While in actual practice, the parts are usually shipped directly to the customer, those of ordinary skill will recognize the benefits and limits of this simplifying assumption and include any significant differences by adding complexity to the analysis and computations to be described below.

Other data and data arrangements may also be provided in step 31 depending on the specific nature of the customers, and parts within a neighborhood without departing from the scope of the invention as defined by the appended claims.

In step 32 a part procurement time performance measure is specified for each customer served by the stocking locations. Part procurement time performance is defined as the percentage of parts in a customer's request rates which can be transferred from any stocking location within a pre-specified time. For example, the customer may have a list of parts which need to be supplied within two hours under the terms of a service contract with the parts supplier. A second set of parts which are deemed to be less critical may need to be supplied within 8 hours, 24 hours, 48 hours, next day, or any other specified delivery requirement. A plurality of part procurement time performance measures may be specified for one or more customers in step 32.

Individual performance measures may be combined when needed by the optimization problem described below. One technique for combining may be to form a weighted average of individual measures, however any other combining technique may be used.

In step 33 the data and performance measures are entered into an optimization computer program. One such program, OSL®, is provided by IBM Corp. of Armonk, N.Y. (OSL is a registered trademark of IBM Corporation). Depending on the capability and limitation of the program, it may be necessary to first formulate a mathematical model of an optimization problem and then enter the model into the program. Other programs build a model as the user enters the data and performance measures.

The mathematical model may comprise a mixed integer problem. The main variables in this mixed integer problem represent the stocking levels for each parts at each stocking location. These decision variables are required to take non-negative integer values. Flow variables are introduced to represent transportation of parts between stocking locations. Flow variables are required to be non-negative, but because these represent average flow rates, the rates may take non-integer values. Other problem formulations and approximations known in the optimization arts may be used. For example in businesses where large quantities of relatively low cost parts are used, it may be an acceptable approximation to allow non-integer stocking levels during problem formulation and solution, but round the optimum stocking levels to the next higher or next lower integer value. In such cases the mathematical model may comprise a linear programming problem, non-linear programming problem, or other type of optimization problem.

Those familiar with the optimization arts will recognize that constraints may also be entered into the optimization program. Equality and inequality constraints may be entered. These usually comprise linear equations and inequalities, however nonlinear constraints may also be entered depending on the capabilities of the programs. Techniques for linearizing nonlinear equations and inequalities over limited regions may also be used without departing form the scope of the invention.

One such constraint may be that the total demand must be satisfied by a primary location and other locations within its neighborhood such that a pre-specified service level is met or exceeded. A service level may be, for example, a contractually agreed number, e.g. 95%, for the part procurement time performance measure.

A simplified mathematical model will now be described for the purpose of illustrating and in no way limiting some of the elements of the present invention. In this model formulation a single part may be required in any quantity by a plurality of customers j=1, . . . and supplied by a plurality of stocking locations l=1, . . . A set of parameters may be defined:

υ: Unit cost of the part

r: Holding cost ($/$ unit cost−week)

Tⱼₗ=1 if travel from customer j to stocking location l is within the pre-specified time

0 otherwise

N₁: Neighborhood set of location l

N₁⁻¹: Set of locations that have location l in their neighborhoods

N(l,l′): the subset of the ordered set of locations representing neighborhood for l that begins at l′ and ends with a central supplying facility.

L: Set of stocking locations, including those in N₁

l(j): Primary location for demand originating from customer j

Dⱼ: Demand rate for the part from customer j

$${D}_{l} = {\sum }_{j ∈ {Z}_{1}} {D}_{j} ,$$

where Z₁ is the set of customers with primary location l

D: Total demand rate for the part including Dₗ

S^{UB}: Stock level upper bounds

α: Service Level (PPT) setting

Vⱼₗ: Physical cost (transportation and handling) per unit between customer j and location l

R: Review period as defined below

τ: Lead time as defined below

c₁c₂: Coefficients used in the linear Poisson approximation, c₁ε[0.8,1], c₂ε[0.375,0.5]

where the review period and lead time are defined below.

With these parameters, a set of solution or decision variables may be defined as:

S₁: Stock level for the part at stocking location l

Yₗ: Approximation of the Poisson flow rate for the part from inventory at stocking location l

λ_{ll′}: Average per unit time flow rate of the part from sending location l′εNₗ₍ⱼ₎ to customers

that have stocking location lεL as a primary location (or alternatively to l as noted above for purpose of this model simplification). Also for planning purposes and model simplification, the average per unit flow from location l′ to location l may be allocated proportionately to customers with stocking location 1 as their primary location by

$$\frac{{D}_{j}}{{D}_{l ( j )}} {λ}_{1 ( j ) {l}^{′} .}$$

Values are then found for these solution variables by minimizing the functional:

$${\sum }_{{1}^{′} ∈ L} υ r ( {S}_{{l}^{′}} - \frac{{Y}_{{1}^{′}}}{R + τ} ) + {\sum }_{j} {\sum }_{{1}^{′} ∈ {N}_{l ( j )}} {V}_{j {1}^{′}} \frac{{D}_{j}}{{D}_{l ( j )}} {λ}_{1 ( j ) {l}^{′}}$$

where the first term represents holding cost and the second term represents transportation cost. This must be minimized subject to the constraint that the PPT service level is met or exceeded:

$${\sum }_{j} {\sum }_{{l}^{′} ∈ {N}_{l ( j )}} {T}_{j {l}^{′}} \frac{{D}_{j}}{{D}_{l ( j )}} {λ}_{1 ( j ) {l}^{′}} \geq D α \qquad ( 1 )$$

Other constraints may be included such as:

$${\sum }_{{l}^{′} ∈ {N}_{1}} {λ}_{{11}^{′}} = {D}_{1} ∀ l ∈ L \qquad ( 2 )$$

which insures that the total demand for the part from customers having 1 as a primary location is satisfied from within the neighborhood, even if not within the pre-specified PPT time.

A constraint:

λ_{ll′}≦D_{l′}S_{l′} ∀l,l′εL (3)

which requires that there be no flow originating from location l′ if the part is not stocked at location l′ may be included for the purpose of speeding up the computer calculations of the optimized solution.

Additional constraints may be added to handle a Poisson distribution of demand:

$${\sum }_{1 ∈ {N}_{{1}^{′}}^{- 1}} {λ}_{{11}^{′}} = {Y}_{{1}^{′}} / ( R + τ ) ∀ {l}^{′} ∈ L \qquad ( 4 )$$

### Y_{l′}≦c₁Sₗ′ ∀l′εL (5)

$${Y}_{{l}^{′}} \leq {c}_{1} ( R + τ ) {\sum }_{1} \sim {\sum }_{l ∈ N ( 1 , {l}^{′} )} {\tilde{λ}}_{11} ∀ {l}^{′} ∈ L \qquad ( 6 )$$

$${Y}_{{1}^{′}} \leq {c}_{2} [ {S}_{{1}^{′}} + ( R + τ ) {\sum }_{1} \sim {\sum }_{1 ∈ N ( 1 , {l}^{′} )} {\tilde{λ}}_{11} ] ∀ 1 , {l}^{′} ∈ L \\ S ∈ {Z}^{+} , S \leq {S}^{UB} , λ \geq 0 , Y \geq 0 \qquad ( 7 )$$

All of the flows to locations that are served by available inventory at l′ should satisfy constraint (4). The average flow rate of parts to customers having stocking location l′ as a primary location across all such locations receiving parts from stocking location l′ is a linear approximation to a Poisson based expression.

Constraints (5) through (7) are hyperplanes approximating a curvilinear Poisson Flow equation. However, these constraints can be replaced by different approximating constraints if a different probability distribution is used.

While the simplified model above is provided for illustration purposes, those skilled in the art will recognize how to extend the model to include multiple parts and multiple service level PPT requirements, or to formulate other optimization models limited only by the appended claims below.

In step 34 inventory levels are computed for each stocking location. The optimization program from step 33 is run to compute the optimum inventory levels. This optimum may represent the minimum overall inventory cost while meeting or exceeding the specified part procurement time measures while also satisfying any other constraints entered into the optimization problem. Alternatively, an upper bound may be specified for overall inventory cost and inventory levels computed which maximizes the percentage of parts which can meet or exceed a pre-specified part procurement time e.g. two hours. Part flow rates between a replenishment center and stocking locations as well as between stocking locations may also be computed in step 34.

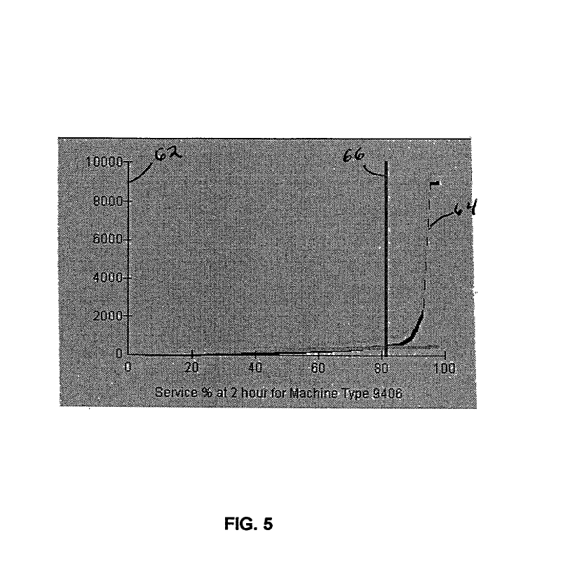

Data flow for step 33 and 34 may also be represented by the model generation 50 and model solution 52 data flows of FIG. 4. However, data flows 50 and 52 do not necessarily correspond to steps 33 and 34 respectively. FIG. 4 merely represents and clarifies some of the data flows which occur as the steps of FIG. 3 are performed. Individual service levels as noted in data flow 56 for each customer may also be computed in step 34. Various results may be depicted graphically or visually as shown in data flow 54 and in FIG. 5 as described below.

In step 35 parts are ordered to maintain the optimum inventory levels computed in step 34. Any ordering system capable of maintaining the optimum inventory levels at each stocking location may be used.

For example, steps 31-35 may be repeated on a periodic basis e.g. daily, weekly, and monthly. The period of repetition is sometimes referred to as a review period R or review interval. Furthermore it is not required that all of steps 31-35 be repeated with the same interval. Ordering, for example may be performed more or less frequently than steps 31-34. One important consideration in selecting a review period may be the lead time T to receive a part once it is ordered.

In addition to determining inventory levels. The present invention has other uses. Three will now be described.

The invention may be used to aid in setting or specifying part procurement time performance measures or in setting upper bounds of inventory cost. For example, in FIG. 5 there is shown a graph of inventory cost vs service percent. Service percent is taken as the specified percentage of parts in the customer request rates which are shipped within the specified procurement time.

A graph such as FIG. 5 is readily constructed through repeated use of the present invention to compute optimum inventory levels, and resulting costs 62, for a series of various specified service levels, without actually ordering the parts. The resulting inventory costs 64 are then entered on a graph as in FIG. 5. Alternatively a series of upper bounds on inventory cost can be specified and the resulting optimum service percents computed using the method of the present invention.

A part supplying company may use such a graph to set a price for differing service levels, e.g. at 82%, 66 as specified in FIG. 5.

The present invention may also be used in deciding whether to add or remove stocking locations from a supply network. Overall inventory costs can be computed with the present stocking locations and compared to costs assuming another stocking location is added or removed from the supply network. Supply business owners can then decide whether there is enough cost benefit to justify making the contemplated change.

The present invention is not limited to use in after-market or replacement parts businesses. It may also be used to determine stocking levels for the marketing of merchandise. In particular for low volume but high value products, a group of retailers, or a company having a chain of locations may use the invention to insure a high probability that a particular product is in stock within a reasonable travel time of a customer. Such a system is particularly valuable for marketing of high end stereos, sports cars, bridal fashions, some jewelry, and furniture and other merchandise where the customer generally wants to see and/or try the product before purchasing it.

While there have been shown and described what are at present considered the preferred embodiments of the invention, it will be obvious to those skilled in the art that various changes and modifications may be made therein without departing from the scope of the invention as defined by the following appended claims.

What is claimed is:

1. A method of determining inventory levels of parts for a plurality of stocking locations, said method comprising the steps of:
providing data for a plurality of customer locations, unit price of said parts, request rates for each of said parts for each of said customer locations, handling costs for each of said stocking locations, and travel time and transportation cost between said stocking locations;
specifying a parts procurement time performance measure;
entering said data and said performance measure into an optimization computer program;
computing said inventory levels of said parts for said plurality of stocking locations using said optimization computer program; and
ordering sufficient numbers of said parts to maintain said inventory levels at said plurality of stocking locations.

2. The method of claim 1, wherein said data for a plurality of customer locations includes travel time and cost to transfer a part from each of said plurality of stocking locations to each of said customer locations.

3. The method of claim 1, wherein said request rates includes a probability distribution for one or more of said request rates.

4. The method of claim 3, wherein said probability distribution is a Poisson distribution.

5. The method of claim 1, wherein said part procurement time performance measure comprises the percentage of parts in said request rates which can be transferred from any said stocking location to each said respective customer location within a pre-specified time.

6. The method of claim 5, wherein said parts are grouped by importance into a plurality of groups and said pre-specified time comprises a corresponding plurality of times.

7. The method of claim 6, wherein inventory levels are computed to minimize overall cost while meeting or exceeding said plurality of times.

8. The method of claim 1, wherein said optimization computer program is a mixed integer optimization program.

9. The method of claim 1, wherein said inventory levels are computed to meet a total inventory cost while maximizing the percentage of said parts in said request rates which can be transferred from any said stocking location to each respective said customer location within said pre-specified time.

10. The method of claim 1, further comprising the step of computing the estimated time for each part to be transferred from any said stocking location to each respective said customer location for each of said parts in said request rates.

11. A computer implemented method of specifying parts inventory levels for a network of stocking locations, said method comprising the steps of:
providing data for a plurality of customer locations, unit price of said parts, request rates for each of said parts for each of said customer locations, handling costs for each of said stocking locations, and travel time and transportation cost between said stocking locations;
specifying a parts procurement time performance measure;
formulating a mixed integer optimization model of said network; and
entering said model on a processor to solve said mixed integer model to obtain said inventory levels for each of said stocking locations in said network.

12. The method of claim 11, wherein said model includes a total inventory cost constraint.

13. The method of claim 11, wherein said inventory levels are solved to minimize overall cost while meeting or exceeding said parts procurement time performance measure.

14. A computer system for controlling inventory levels of parts for a plurality of stocking locations, comprising:
a processor;
one or more files on said computer system containing data for a plurality of customer locations, unit price of said parts, request rates for each of said parts for each of said customer locations, handling costs for each of said stocking locations, and travel time and transportation cost between said stocking locations;
means for computing on said processor a parts procurement time performance measure;
an optimization computer program on said processor for calculating said inventory levels of parts for said plurality of stocking locations; and
an ordering system on said computer system for maintaining said inventory levels at said plurality of stocking locations.

15. The system of claim 14, wherein said data for a plurality of customer locations includes travel time and cost to transfer a part from each of said plurality of stocking locations to each of said customer locations.

16. The system of claim 14, wherein said request rates includes a probability distribution for one or more of said request rates.

17. The system of claim 14, further comprising a mixed integer model of said network.

18. The system of claim 17, wherein said model is formulated to minimize overall cost while meeting or exceeding a pre-specified parts procurement time performance measure.

19. A computer program product for instructing a processor to determine inventory levels of parts for a plurality of stocking locations, said computer program product comprising;
a computer readable medium;
first program instruction means for providing data for a plurality of customer locations, unit price of said parts, request rates for each of said parts for each of said customer locations, handling costs for each of said stocking locations, and travel time and transportation cost between said stocking locations;
second program instruction means for specifying a parts procurement time performance measure;
third program instruction means for entering said data and said performance measure into an optimization computer program;
fourth program instruction means for computing said inventory levels of said parts for said plurality of stocking locations using said optimization computer program; and
fifth program instruction means for ordering sufficient numbers of said parts to maintain said inventory levels at said plurality of stocking locations; and wherein
all said program instruction means are recorded on said medium.
